(19) United States
(12) Patent Application Publication
(10) Pub. No.: US 2017/0103437 A1
(43) Pub. Date: Apr. 13, 2017

(54) YIELD DETERMINATIONS FOR A REMAINING INVENTORY OF A PRODUCT

(71) Applicant: Amadeus S.A.S., Biot (FR)

(72) Inventors: Bastien Guillard, Antibes (FR); Michael Robini, Nice (FR); Roman Rubsamen, Puget sur Argens (FR); Pierre-Yves Rault, Antibes (FR)

(21) Appl. No.: 14/882,051

(22) Filed: Oct. 13, 2015

(51) Int. Cl. G06Q 30/06; H04L 29/06; G06Q 30/02; G06Q 10/08

(52) U.S. Cl. CPC G06Q 30/0605; G06Q 10/087; H04L 63/0281; G06Q 30/02

(57) ABSTRACT

Systems, methods, and computer program products that determine yield for units of perishable inventory, such a seats on a flight. Yield for future sales of seats is determined based on a weighted average of prices for used tickets and unused tickets for flights that have departure dates in the future. To increase the amount of data on which to base the yield, simulated reservation records are generated based on expected demand for flights during an open reservation window. Proxy tickets are then generated for the simulated reservation records and for reserved but unbooked reservation records. These proxy tickets are stored in a database of proxy tickets that is updated periodically to reflect changes in available inventory, pricing, and reservation context. The prices of the proxy tickets are then used to enrich booked ticket and flown ticket data for calculating yield.

### BACKGROUND

The invention generally relates to computers and computer software, and in particular to systems, methods, and computer program products that determine yield for perishable units of inventory.

Service products, such as seats on a flight, hotel rooms, or rental cars, have several characteristics that create challenges in determining a price at which the products should be sold. One characteristic is that service products have a perishable inventory. That is, if the product is not sold prior to the time at which the product is available for use, or the “perish time”, the product is lost. For example, once a flight departs, any revenue that could have been realized from an unsold seat cannot be recovered. Likewise, lost revenue from unoccupied hotel rooms or unrented cars is permanently lost. Service products also tend to have an inventory with a relatively fixed capacity. That is, it is typically difficult and expensive for the service provider to adjust capacity to meet changes in demand. Service products are also typically purchased in advance of their intended use, sometimes weeks or months ahead of time, before the demand for the service product on the date in question is fully known.

When faced with an offer to purchase a product, the service provider must determine whether to accept the offer, or wait to see if a better offer materializes prior to the perish time. If a better offer is received, the provider may realize a larger amount of revenue for the sale of the product. However, if a better offer does not materialize, and a portion of the inventory goes unsold, the provider will have lost the revenue that would have been received by accepting the earlier offer. Thus, when setting prices, service providers must balance the probability that a better offer may be received after their inventory has been fully sold against the probability that unsold inventory will perish.

The process of setting prices in the service industry is often referred to as revenue management. The goal of revenue management is to maximize revenue through pricing and inventory control. Pricing control typically involves segmenting the inventory by establishing a plurality of classes within the inventory, with each class being offered at a different price. Inventory control then determines how much of the available inventory to allocate to each class, with the goal of selling as much inventory as possible without refusing any offers to purchase inventory allocated to higher priced classes.

Pricing and inventory control typically relies on projected pricing, referred to as the yield, of the product to determine how to both allocate inventory between classes, and price inventory within each class. If yield projections are inaccurate, too much inventory may allocated to the wrong classes, resulting in insufficient inventory to meet demand for higher priced classes, or excessive unsold inventory that spoils on the perish date. In either case, revenue may be lost.

Thus, improved systems, methods, and computer program products that determine the yield of perishable products are needed.

### SUMMARY

In an embodiment of the invention, a system that determines a yield for a remaining inventory of a first product having a first perish date is provided. The system includes one or more processors in communication with a memory. The memory stores data comprising program code that, when executed by the one or more processors, causes the system to determine, prior to the first perish date, a first price for a first unit of the first product which is reserved, a second price for a second unit of the first product which is available, and a third price paid for a third unit of a second product having a second perish date which has passed. The program code further causes the system to determine the yield for the remaining inventory based on a weighted sum comprising the first price, the second price, and the third price.

In another embodiment of the invention, a method of determining the yield for the remaining inventory of the first product is provided. The method includes determining, prior to the first perish date, the first price for the first unit of the first product which is reserved, the second price for the second unit of the first product which is available, and the third price paid for the third unit of the second product having the second perish date which has passed. The method further includes determining the yield for the remaining inventory based on the weighted sum comprising the first price, the second price, and the third price.

In another embodiment of the invention, a computer program product for determining the yield for the remaining inventory of the first product is provided that includes a non-transitory computer-readable storage medium including program code. The program code is configured, when executed by the one or more processors, to cause the one or more processors to determine, prior to the first perish date, the first price for the first unit of the first product which is reserved, the second price for the second unit of the first product which is available, and the third price paid for the third unit of the second product having the second perish date which has passed. The program code further causes the one or more processors to determine the yield for the remaining inventory based on the weighted sum comprising the first price, the second price, and the third price.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including a reservation system, a ticketing system, a fare system, a revenue management system, and a yield generator in communication via a network.

FIG. 2 is a diagrammatic view of an exemplary computer for hosting the reservation system, ticketing system, fare system, revenue management system, and yield generator of FIG. 1.

FIG. 3 is a diagrammatic view showing additional details of the reservation system, ticketing system, fare system, and yield generator of FIG. 1.

FIG. 4 is a graphical view illustrating a distribution of used tickets, booked tickets, reserved proxy tickets, and simulated proxy tickets that may be used to determine yield by the yield generator of FIG. 3.

FIG. 5 is a diagrammatic view illustrating a relationship between time and a used reservation record, a partially used reservation record, and an unused reservation record.

### DETAILED DESCRIPTION

Embodiments of the invention may be implemented by a processing and database system. The processing and database system may comprise one or more computerized sub-systems, such as a reservation system, a ticketing system, a fare system, a revenue management system, and a yield generator. Each of these systems may be a part of, or provided by, a Global Distribution System (GDS), a system operated by a carrier or other provider of travel products, or any other suitable processing and database system.

The yield generator may operate cooperatively with the other systems to determine a yield for units of unsold inventory of a travel product. Travel products may include, for example, seats on a transport (e.g., a flight or train), rental cars, hotel rooms, or access to activities and entertainment. To determine yield, the yield generator may obtain data relating to historical prices for units of the product that were used, prices of booked but as yet unused product, prices of proxy tickets for reserved products that have not been booked, and prices of proxy tickets for simulated reservation records for product inventory that has not been reserved. The yield generator may compute the yield as a weighted sum of these prices, and provide the yield to a revenue management system. The revenue management system may then determine pricing and allocation of inventory based at least in part on the yield.

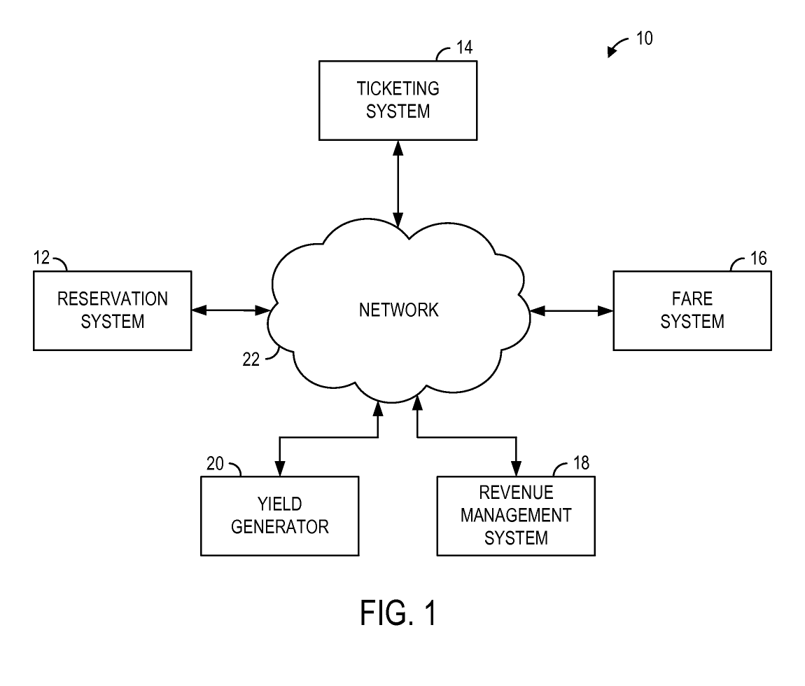

Referring now to FIG. 1, an operating environment 10 in accordance with an embodiment of the invention may include a reservation system 12, a ticketing system 14, a fare system 16, a revenue management system 18, and a yield generator 20. Each of the reservation system 12, ticketing system 14, fare system 16, revenue management system 18, and yield generator 20 may communicate through a network 22. The network 22 may include one or more private or public networks (e.g., the Internet) that enable the exchange of data.

The reservation system 12 may manage information and conduct transactions related to managing inventory, setting prices, reserving, and booking travel products, such as flights. To this end, the reservation system 12 may comprise an inventory management system that maintains a database of available seats, or units of inventory, on each flight operated by the carrier. The inventory system may determine availability and pricing for the units of inventory, and may be integrated with the reservation system 12 or provided as a separate system. The inventory system may define how many seats are available on a particular flight or in a particular market by opening and closing individual booking classes in accordance with rules defined by the carrier or by the revenue management system. In the context of air travel, an available unit of inventory in the inventory system may not necessarily correspond to a specific physical seat on an aircraft. For example, available inventory may exceed the number of physical seats in a market to allow for overbooking

The reservation system 12 may be operated by the provider (e.g., a carrier), or by an entity authorized by the provider to manage the reservation system 12. The reservation system 12 may host one or more databases that maintain data for tracking the sale and availability of inventory. The reservation system 12 may be linked to, or hosted by, a Global Distribution System (GDS) (not shown), which may provide access to the reservation systems of multiple providers. The reservation system 12 may be enable authorized users to reserve, book, and pay for units of inventory, such as airline tickets. The reservation system 12 may also interact with other reservation systems and third party seller systems (not shown), either directly or through the GDS, to enable a validating carrier or third party seller to sell tickets for seats provided by an operating carrier. The operating carrier may then bill the validating carrier for the services provided. The reservation system 12 may also respond to queries received from other systems for itinerary data, such as data relating to a flight or passenger.

The ticketing system 14 may comprise a computer system configured to maintain records of the booking and use of tickets. These records may comprise electronic tickets maintained in one or more databases. The ticketing system 14 may track the status of tickets issued for travel products such as flights by storing data to, and retrieving data from, the databases. Purchasing a ticket may involve pricing, booking, and ticketing of the underlying travel product. The resulting electronic ticket may be comprised of one or more electronic coupons. Each coupon may correspond to one or more of the segments or products of the travel itinerary defined by a corresponding reservation record in a database of reservation records. The electronic ticket coupons may identify the segments for which the ticket can be used to obtain a boarding pass, or other products that comprise the travel itinerary. In addition to tickets for products that have been booked for future travel, the ticketing system 14 may maintain databases that store electronic documents relating to tickets for products that have been used, proxy tickets for products that have been reserved but not booked, and proxy tickets for products which have been neither booked nor reserved.

The fare system 16 may determine fares for units of inventory based on a pricing context. The pricing context may comprise parameters that define a set of conditions under which the unit of inventory is being priced. Examples of pricing context for air travel may include, but are not limited to, a pricing date, an office code that identifies the ticketing office originating the ticket, a passenger type code that identifies a type of passenger (e.g., infant, child, adult, adult standby, military, etc.), a corporate code that identifies a negotiated rate or corporate discount for which the traveler is eligible, and a booking class code that identifies a class of service (e.g., first class, business class, economy class, etc.).

In the context of air travel, each unit of inventory may comprise one or more “priceable units”. A priceable unit is a combination of one or more segments which comprises a flight between an origination and a destination point served by the carrier. The priceable unit may therefore be the simplest combination of segments that can be individually booked and ticketed. The simplest priceable unit is a one-way priceable unit, which may comprise a single segment. Other priceable units may include round trips and circle trips built from two or more segments that form a closed loop. A booked flight may include one or more priceable units, with each priceable unit comprising one or more segments.

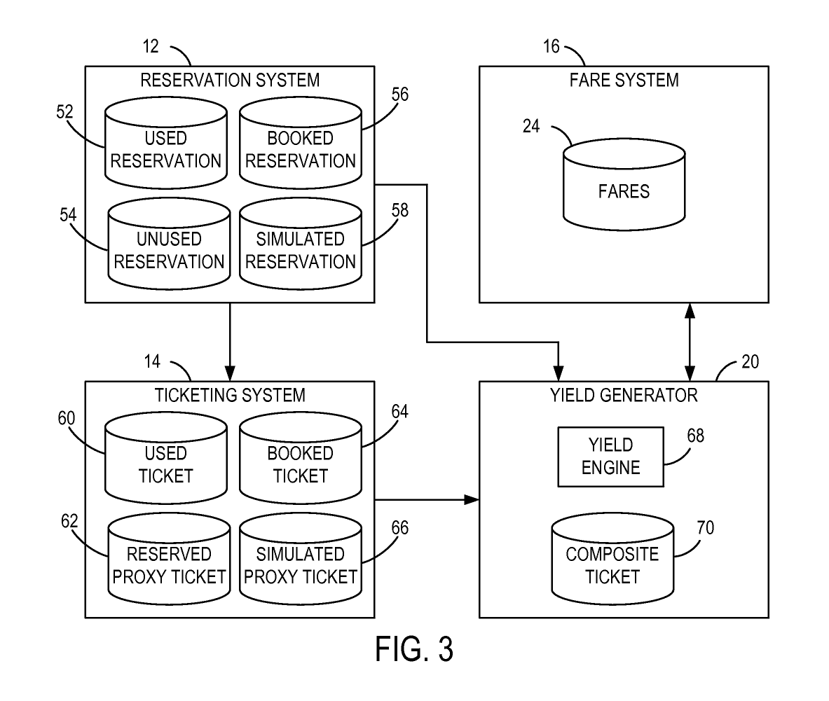

The fare system 16 may maintain a database of fares 24 (FIG. 3), with each fare being stored in a database record. Each database record, in turn, may be associated with one or more corresponding parameters comprising the pricing context and the segments comprising the unit of inventory for which the fare is being determined. The fare system 16 may thereby determine a fare for a particular unit of inventory by searching the database for fares corresponding to the pricing context of the flight or other travel product in question. The database of fares 24 may be refreshed on a regular basis, such as once a day, by a fare data feed from the carrier.

The revenue management system 18 may be configured to determine an expected future revenue impact of making units of inventory available for purchase in each of several booking classes to provide segmented pricing. The revenue management system 18 may determine availability levels and prices to maximize revenue generated by the sale of inventory. In some cases, this may involve the minimization of inventory that goes unsold, such as empty seats in an aircraft, empty rooms in a hotel, unrented cars for a car rental company, or any other perishable inventory. The travel product may have a limited inventory, and a perish time by which the inventory must be sold to avoid loss of any unsold units of inventory.

By way of example, a carrier may have a maximum number of seats available in each of one or more cabins for a specific market or flight. Once an airplane has left the gate, the profit from unsold seats is forever lost, and the product is said to have perished or spoiled. In this exemplary case, the actual perish time may occur prior to departure to account for the time required for processing the ticket, check in, security screening, boarding, and so forth. Travel services other than airline seats may also have a limited inventory and perish time. For example, a hotel may have a fixed number of rooms available, or an attraction may have a limited number of tickets that can be sold for a given performance. In any case, unsold hotel rooms, rental cars, or attraction tickets may also perish, as revenue cannot be recovered for periods where rooms sit vacant, cars were not rented, or attractions were not fully attended.

The revenue management system 18 may separate the process of revenue optimization into pricing and inventory control functions. As discussed above, pricing may be segmented by establishment of booking classes, and may involve tariffs within those classes for each specific market. Product inventory control may be implemented by periodic adjustment of nested booking limits for the various classes of service so as to optimize the passenger mix, thereby maximizing generated revenue. In particular, the objective may be to fly each aircraft as full as possible without allowing earlier-booking discount-fare passengers to displace later-booking full-fare passengers.

The cost of not selling a unit of inventory may be a current expected value of selling the unit at some time in the future, or “opportunity cost” of the unit. The opportunity cost, or “bid-price” may vary depending on the amount of remaining inventory and the amount of time remaining until the perish time. The bid-price may represent a probabilistic expected revenue for the next seat offered to sell for a given remaining inventory and amount of time until the service perishes. To maximize revenue for this limited inventory, the revenue management system 18 may open and close certain classes of service based on the bid-price. This gating strategy may be based on bid-prices computed on a periodic basis (e.g., once a day), which may in turn be used to determine availability for each booking class. Plotting the bid-price verses remaining units of inventory n at time t may produce a bid-price vector BP(n, t). The bid-price vector BP(n, t) may provide a minimum price the carrier should accept for booking the next available seat for a given remaining inventory n and time t.

The revenue management system 18 may determine how many units from the remaining inventory should be made available in each booking class based on the bid-price and yield. The yield may reflect an expected revenue per unit sold, and may vary by booking class, market, and perish date for units of inventory. If the bid-price is lower than the yield, units of inventory should typically be made available in the booking class. In contrast, if the bid-price is above the yield, the booking class should be closed since the opportunity cost of the next unit of inventory exceeds the price for which the ticket is expected to sell. Because yield directly affects the number of units of inventory that should be made available in each booking class to maximize revenue, the accuracy of predicted yield may contribute to the performance of the revenue management system 18. Thus, an increase in the quality of the yield prediction may improve how well the revenue management system 18 sets prices and allocates inventory between booking classes. Improvements in accuracy of the predicted yield may thereby increase both the revenue of the provider as well as customer satisfaction through reductions in denied boarding and/or lack of available units for later arriving full-fare passengers.

To this end, the yield generator 20 may determine yields for units of inventory, and provide these yields to the revenue management system 18. The yield generator 20 may calculate yield based on historical prices of sold units, prices of currently booked but unused units, prices of reserved but unbooked units, and unreserved units. By using available data on expected future use of booked, reserved, and unreserved units in addition to the historical data, the yield generator 20 may determine yield more accurately than conventional systems that rely on historical data alone.

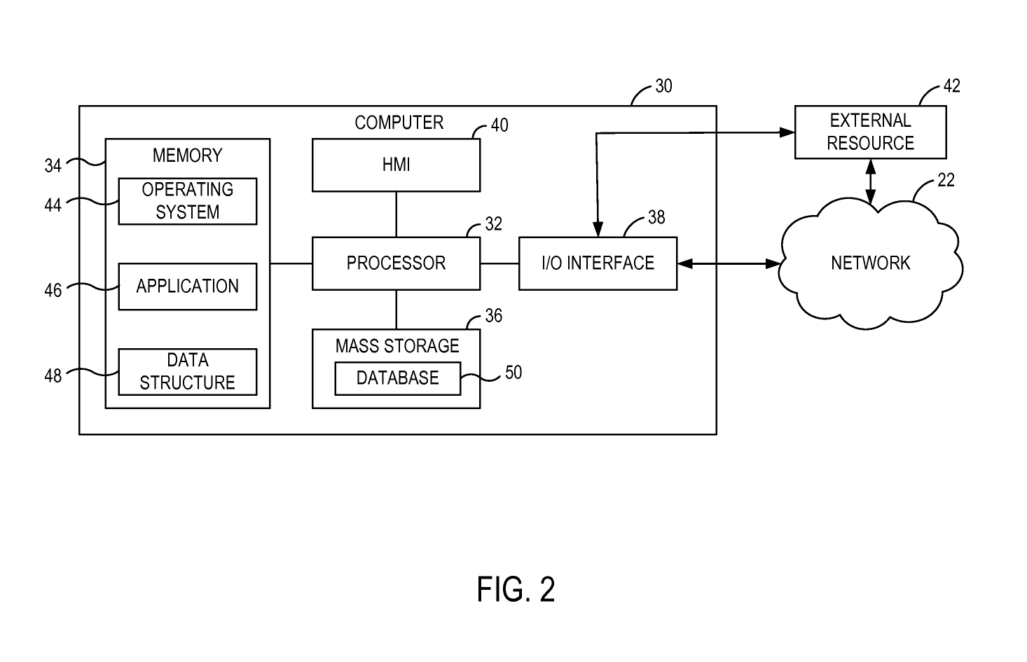

Referring now to FIG. 2, the reservation system 12, ticketing system 14, fare system 16, revenue management system 18, and yield generator 20 of operating environment 10 may be implemented on one or more computer devices or systems, such as exemplary computer 30. The computer 30 may include a processor 32, a memory 34, a mass storage memory device 36, an input/output (I/O) interface 38, and a Human Machine Interface (HMI) 40. The computer 30 may also be operatively coupled to one or more external resources 42 via the network 22 or I/O interface 38. External resources may include, but are not limited to, servers, databases, mass storage devices, peripheral devices, cloud-based network services, or any other suitable computer resource that may be used by the computer 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 36 may include data storage devices such as a hard drive, optical drive, tape drive, volatile or non-volatile solid state device, or any other device capable of storing information.

The processor 32 may operate under the control of an operating system 44 that resides in memory 34. The operating system 44 may manage computer resources so that computer program code embodied as one or more computer software applications, such as an application 46 residing in memory 34, may have instructions executed by the processor 32. The processor 32 may also execute the application 46 directly, in which case the operating system 44 may be omitted. The one or more computer software applications may include a running instance of an application comprising a server, which may accept requests from, and provide responses to, one or more corresponding client applications. One or more data structures 48 may also reside in memory 34, and may be used by the processor 32, operating system 44, or application 46 to store or manipulate data.

The I/O interface 38 may provide a machine interface that operatively couples the processor 32 to other devices and systems, such as the network 22 or external resource 42. The application 46 may thereby work cooperatively with the network 22 or external resource 42 by communicating via the I/O interface 38 to provide the various features, functions, applications, processes, or modules comprising embodiments of the invention. The application 46 may also have program code that is executed by one or more external resources 42, or otherwise rely on functions or signals provided by other system or network components external to the computer 30. Indeed, given the nearly endless hardware and software configurations possible, persons having ordinary skill in the art will understand that embodiments of the invention may include applications that are located externally to the computer 30, distributed among multiple computers or other external resources 42, or provided by computing resources (hardware and software) that are provided as a service over the network 22, such as a cloud computing service.

The HMI 40 may be operatively coupled to the processor 32 of computer 30 to enable a user to interact directly with the computer 30. The HMI 40 may include video or alphanumeric displays, a touch screen, a speaker, and any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A database 50 may reside on the mass storage memory device 36, and may be used to collect and organize data used by the various systems and modules described herein. The database 50 may include data and supporting data structures that store and organize the data. In particular, the database 50 may be arranged with any database organization or structure including, but not limited to, a relational database, a hierarchical database, a network database, an object-oriented database, or combinations thereof.

A database management system in the form of a computer software application executing as instructions on the processor 32 may be used to access the information or data stored in records of the database 50 in response to a query, where a query may be dynamically determined and executed by the operating system 44, other applications 46, or one or more modules. Although embodiments of the invention may be described herein using relational, hierarchical, network, object-oriented, or other database terminology in specific instances, persons having ordinary skill in the art will understand that embodiments of the invention may use any suitable database management model, and are not limited to any particular type of database.

FIG. 3 illustrates the reservation system 12, ticketing system 14, fare system 16, and yield generator 20 in more detail. The reservation system 12 may include a used reservation database 52, an unused reservation database 54, a booked reservation database 56, and a simulated reservation database 58. The used reservation database 52 may maintain reservation records corresponding to reservations having units that were booked and used, e.g., booked units that are past their perish time. The unused reservation database 54 may maintain reservation records corresponding to reservations having units that have been reserved, but that have not been booked and have not passed their perish time.

The booked reservation database 56 may maintain reservation records corresponding to reservations having units that have been booked, but that have not been used (e.g., booked reservations for units having a perish time in the future). The simulated reservation database 58 may include simulated reservation records for units that have not been reserved. A simulated reservation record may be generated by providing a simulated reservation request to the reservation system 12. The number and type of simulated reservation requests may be determined based on an expected demand for units. The reservation system 12 may be configured to recognize simulated reservation records so that they do not tie up units of inventory, thereby allowing the units to be reserved by travellers.

In an embodiment of the invention, one or more of the reservation records may comprise a Passenger Name Record (PNR). Each reservation record may be generated, at least in part, by the reservation system 12, and may comprise one or more database records that contain itinerary and passenger information associated with one or more reserved seats on a flight. The used reservation database 52, unused reservation database 54, booked reservation database 56, and simulated reservation database 58 may be independent databases, or partitions within a single database. One or more of these databases may be accessible by other systems, such as a customer management system (not shown), and may include records that contain data defining an itinerary for a particular trip, passenger, or group of passengers. The defined itinerary may include travel products from multiple travel product providers or a single provider. In any case, to facilitate locating the records in each database, a record locator or other suitable record identifier may be associated with each reservation record.

The ticketing system 14 may include a used ticket database 60, a reserved proxy ticket database 62, a booked ticket database 64, and a simulated proxy ticket database 66. The ticket databases 60, 62, 64, 66 may comprise independent databases, or partitions within a single ticket database. The used ticket database 60 may maintain records corresponding to electronic tickets for units of inventory that were booked and used, e.g., flown tickets. The reserved proxy ticket database 62 may maintain records corresponding to proxy tickets for units of inventory that have been reserved, but not yet booked, and that have not passed their perish time. The booked ticket database 64 may maintain records corresponding to tickets for units that have been booked, but that have not been used, e.g., booked reservations for units having a perish time in the future. The simulated proxy ticket database 66 may include records corresponding to proxy tickets for units of inventory that have not been reserved, e.g., units of inventory corresponding to a simulated reservation record in the simulated reservation database 58.

The yield generator 20 may include a yield engine 68 and a composite ticket database 70. The yield engine 68 may be configured to generate a yield for one or more units of inventory in each booking class based on prices of tickets in the composite ticket database 70. The composite ticket database 70 may maintain records corresponding to tickets in the used ticket database 60, reserved proxy ticket database 62, booked ticket database 64, and simulated proxy ticket database 66. The composite ticket database 70 may thereby maintain records that provide prices for used travel products (e.g., flown tickets), reserved travel products that have yet to be used (e.g., reserved flights that have not been ticketed), booked travel products that have yet to be used (e.g., ticketed flights that have yet to depart) and as yet unreserved travel products (e.g., open seats on a flight). As will be discussed in more detail below, the yield engine 68 may determine yield by calculating a weighted average of prices from each of these four categories of pricing data.

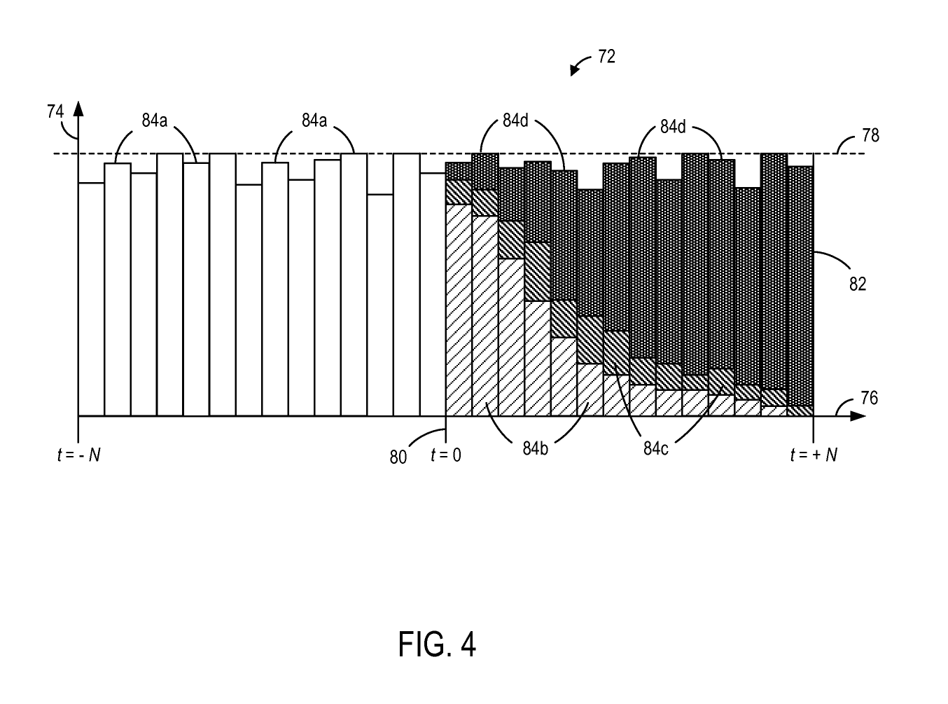

Referring now to FIG. 4, a graphical diagram depicts a bar graph 72 illustrating an exemplary distribution of the types of data provided to and maintained by the composite ticket database 70. The bar graph 72 includes a vertical axis 74 corresponding to a load factor (i.e., the ratio between the number of units of inventory utilized and the number of units of inventory available) and a horizontal axis 76 corresponding to time. A horizontal dashed line 78 may represent a 100% load factor, and vertical line 80 may indicate the present time, or t=0. Bars to the left of vertical line 80 may represent historical sales data, and bars to the right of vertical line 80 may represent expected future sales data. The vertical axis 74 may intersect the horizontal axis 76 at a point in time that is N of units of time (e.g., 365 days) in the past, or t=−N. Vertical line 82 may intersect the horizontal axis 76 at a point in time that is N units of time in the future, or t=+N. The period of time between t=0 and t=+N may define a reservation window during which units of inventory can be reserved, e.g., t+365 days or one year into the future.

The bar graph 72 includes a plurality of bars 84a-84d, each representing a number of units of inventory. Persons having ordinary skill in the art will understand that the number of bars 84a-84d depicted is for illustrative purposes only, and the actual number of units of time over which units of inventory are allocated may be different than shown. Bars 84a to the left of t=0 may represent numbers of units of inventory sold and used in the past, e.g., flown tickets. Bars to the right of t=0 include bars 84b, which may represent tickets for units of inventory that have been booked, bars 84c, which may represent reserved proxy tickets for units of inventory that have been reserved but not booked, and bars 84d, which may represent simulated proxy tickets based on simulated reservation records for units that have not been reserved.

The reservation records stored in the booked reservation database 56 of reservation system 12, and the associated booked tickets stored in the booked ticket database 64, may correspond to flights that have yet to depart, i.e. flights for which the reservation window is still open. These booked tickets may be represented by bars 84b, and may provide indications of new booking trends for the associated routes and markets. However, because the tickets represented by bars 84b only represent a portion of the expected bookings, their use without further processing could lead to errors in forecast yield. For example, flights close to their departure date may have received almost all their bookings. In contrast, flights with departure dates further into the future may be almost empty. This relationship between time and booked tickets may be seen by comparing the relative vertical dimensions of bars 84b as time moves to the right along the horizontal axis 76. Moreover, the distribution of traffic between classes of service observed at time t=0 with a scheduled departure date of time t=+m may be quite different from the final distribution of traffic at the departure date.

One mechanism that may contribute to changes in traffic distribution as the departure date approaches are the differences between the behaviour of leisure travellers and business travellers. Leisure travellers may have a lower willingness to pay, which may induce them to book low-cost classes of service well before the departure date. In comparison, business travellers may have both a higher willingness to pay and less notice that travel is necessary. This may result in a tendency for business travellers to book higher-cost classes of service closer to departure time as compared to leisure travellers. Consequently, the traffic distributions determined based on existing tickets alone may be inaccurate.

To determine expected traffic distributions for future flights at the time of departure, embodiments of the invention may take into account reservations that are not yet ticketed and unreserved units of inventory. To account for unbooked reservations, the ticketing system 14 may generate a proxy ticket in the reserved proxy ticket database 62 for each reserved seat that has not yet been booked. Each of these reserved proxy tickets may correspond to a reservation record in the unused reservation database 54 of reservation system 12. The reserved proxy tickets may also be forwarded to and stored in the composite ticket database 70 for use by the yield engine 68. As illustrated by the bars 84b and 84c of bar graph 72, the proxy tickets may be combined with the ticketed reservation records to provide additional data used for the yield engine 68.

To account for unreserved units of inventory, the reservation system 12 may generate simulated reservation records based on an expected demand for seats for each time period between t=0 and t=+N. These simulated reservation records may be stored in the simulated reservation database 58 for use by the ticketing system 14. The ticketing system 14 may generate proxy-tickets using the simulated reservation records, and store these simulated proxy tickets in the simulated proxy ticket database 66. The simulated proxy tickets may also be forwarded to and stored in the composite ticket database 70 for use by the yield engine 68. As illustrated by the bars 84d of bar graph 72, the simulated proxy tickets may be combined with the booked tickets (bars 84b) and the reserved proxy tickets (bars 84c) to provide a complete set of expected sales for use by the yield engine 68.

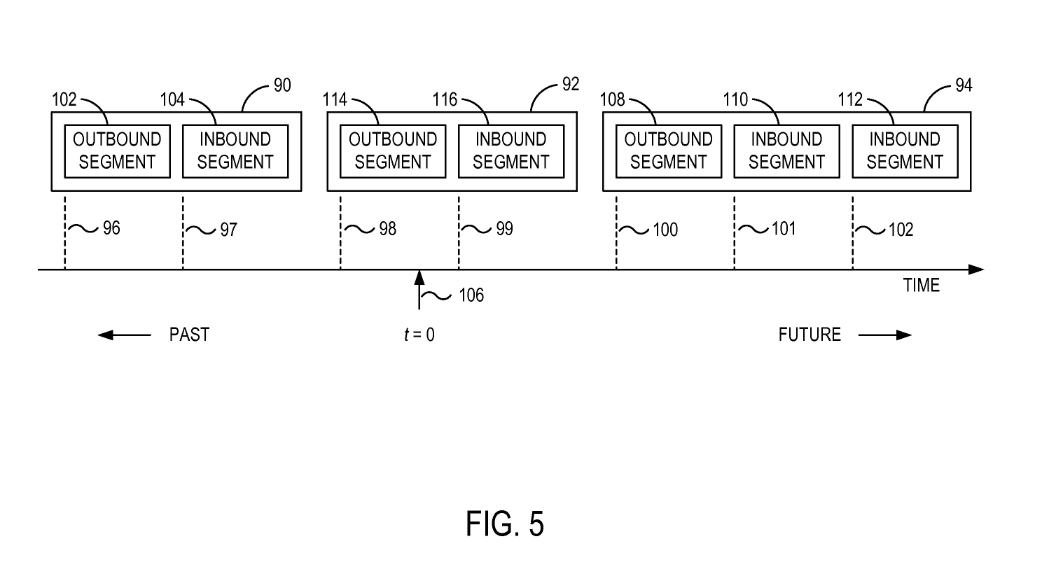

Referring now to FIG. 5, a diagrammatic representation of a plurality of reservation records 90, 92, 94 is presented. The reservation records 90, 92, 94 are depicted with segments scheduled to depart at different times, as indicated by dashed lines 96-102. Reservation record 90 includes an outbound segment 102 and an inbound segment 104, each with a corresponding departure time that has already occurred, i.e., that is to the left of a line 106 indicating t=0, or the present time. Thus, reservation record 90 may depict a used reservation that is stored in the used reservation database 52. In contrast, reservation record 94 includes an outbound segment 108, an inbound segment 110, and an inbound segment 112, each with a corresponding departure time 100-102 in the future. Thus, reservation record 94 may depict an unused reservation that is stored in the unused reservation database 54.

In contrast, reservation record 92 includes an outbound segment 114 with a departure time 98 that has already occurred, and an inbound segment 116 with a departure time 99 that is in the future. Because reservation record 92 includes both a used and an unused segment, it is considered “partially-used”. The definitions of unused, partially-used, and used as applied to reservation records may also be extended to tickets that include multiple segments. Flown and unflown segments of partially-flown tickets may be processed accordingly and used by the yield generator 20 in generating the expected yield.

As described above, a unit of inventory for a travel product may pass through various states over time. The unit of inventory may initially come into existence in the form of an available seat on a flight. In response to receiving a reservation request from a traveler, the unit of inventory may be associated with a record in a reservation database, such as a PNR. A corresponding ticket may not exist until the reservation is booked. Booking may occur in response to the traveler confirming and paying for the travel products defined by the reservation record. Booking may be triggered, for example, by sending a “print ticket” (e.g., TTP) command to the ticketing system 14. For a reservation record including more than one passenger, booking the reservation may result in the generation of multiple tickets by the ticketing system, e.g., one ticket for each passenger associated with the flight being booked in the reservation record. Each of these newly created tickets may be embodied as, or associated with, a record in a ticket database. In an embodiment of the invention, entries may be created in a Central Ticketing Database (CTS) of an Electronic Ticketing System of either the carrier or the GDS. In any case, prior to the departure time of any of the tickets, the segments defined by the reservation record have yet to be used. That is, the corresponding ticket is unflown.

The yield may be provided to the revenue management system as a monetary value, e.g., the payment to book the unit of inventory. That is, yield may be provided by the yield generator at a passenger level. To facilitate generation of the yield, inputs to the yield generator may therefore also be provided at the passenger level, e.g., as either used, booked, or proxy tickets rather than as unprocessed reservation records, which may include multiple passengers. By generating tickets from each reservation record, and feeding these tickets to the yield engine 68, embodiments of the invention may facilitate distribution of revenue at the reservation record level among each passenger defined in the reservation records. In an alternative embodiment of the invention, data from the reservation records could be processed into type of electronic document or file other than a ticket, so long as the resulting document defined price at the passenger level for the travel product in question.

In the context of air-travel, possible configurations for feeding ticket data to the yield generator 20 may include, but are not limited to, interactive feeding, file dumping, and database querying. Interactive feeding may comprise transmitting a notification to the yield generator 20 using, for example, an Electronic Data Interchange For Administration, Commerce and Transport (EDIFACT) message. One such EDIFACT message that could be used to transmit this notification may be TKTREQ. A message may be transmitted for each updated ticket, i.e., each time an entry is created, updated, or deleted in the ticketing database. Messages may be sent each time a change to the ticketing database is detected, or as batches at predetermined intervals. Persons having ordinary skill in the art will further understand that other protocols could also be used to transmit the aforementioned messages other than EDFACT, such as XML, binary, JSON, or any other suitable protocol.

File dumping may include configuring a trigger that causes the ticketing system 14 to dump flown and unflown tickets into a ticketing export file, which may then be transmitted to the composite ticket database 70. Database querying may include connecting the yield generator 20 to, or integrating the yield generator 20 with, the ticketing system 14. In this embodiment, the yield engine 68 could query the ticket databases 60, 62, 64, 66 directly, in which case the composite ticket database 70 could be omitted.

The yield from used travel products (e.g., flown tickets) may be generally immutable. However, the yields calculated from unused travel products (e.g., unflown booked tickets, reserved proxy tickets, simulated proxy tickets) may change if the unused travel products are exchanged, refunded, or ultimately go unbooked. For example, the yield determined from unflown tickets may change in response to reaccomodations, cancellation, exchange of the unflown tickets, or any other event that alters the reservation context of the unflown ticket. In order to account for changes in unflown tickets, embodiments of the invention may notify the yield generator 20 of events that could alter the yield calculated from unflown tickets. This notification may be accomplished by transmitting additional TKTREQ messages, adding flags into a tickets export file, or any other suitable method.

Changes to the used ticket database 60 may be relatively predictable, with new records being added for flown tickets, and old records being deleted as they age out. In contrast, changes to the reserved proxy ticket database 62, booked ticket database 64, and simulated proxy ticket database 66 may be relatively frequent and random as the unflown reservations and proxy tickets are updated or removed. Consequently, the composite ticket database 70 may be updated from the unused/proxy ticket databases 62, 64, 66 more frequently than from the used ticket database 60.

Used ticket data added to the composite ticket database 70 of yield generator 20 may remain unaltered for the duration of the time the data is maintained in the composite ticket database 70. After each period of time (e.g., every 24 hours), the composite ticket database 70 may be enriched with one period's worth of additional used ticket data. In contrast, existing unused ticket images in the composite ticket database 70 may change each time the composite ticket database 70 is updated due to changes in the corresponding reservation record. Updates to the databases of reservation system 12 may include, for example, creation of a new reservation, cancellation of an existing reservation, or reaccomodation of an existing reservation. These updates may, in turn, trigger creation of new tickets, or updates to existing booked or proxy tickets. The updates to the databases of the ticketing system 14 may in turn trigger updates to the composite ticket database 70, as described above.

Because tickets are not generated in conventional ticketing systems until the underlying reservation is booked, unbooked reservation records may be unreferenced by conventional ticketing databases. Thus, to use these records with a conventional ticketing system, the yield generator 20 would have to retrieve the unbooked reservation records from the reservation database. As described above, reservation records including more than a single passenger may be unable to provide data at the passenger level. Embodiments of present invention may solve this problem by generating proxy tickets using data extracted from unbooked reservation records.

Proxy tickets may be generated on a regular basis by performing a full scan of reservation databases in the reservation system 12, and forwarding any unbooked reservation records to a dedicated ticketing module that generates proxy tickets. The proxy ticketing process may be conducted in parallel with standard ticketing processes that are applied to booked reservation records. By performing the proxy ticketing in parallel, the ticketing system 14 may avoid impacting either the standard ticketing process or the booked ticket database 64 with proxy tickets. The proxy ticketing process may duplicate the standard ticketing process, thereby generating proxy tickets suitable for generating yields. The proxy tickets may then be stored in a dedicated database, e.g., the reserved proxy ticket database 62. Because the content and structure of the resulting proxy tickets may be essentially the same as booked tickets, the above process may enable the ticketing system 14 to use the same processes to feed the yield generator 20 as for the booked tickets, e.g., interactive feeding, file dumping, and database querying.

In some cases, a reservation record may be generated that is never booked by the traveler. That is, the traveler may fail to confirm or pay for the reserved travel product prior to the perish time. To prevent these types of reservations from tying up inventory that could be sold to another traveler, the reservation system 12 may include a time limit feature. The time limit feature may set a maximum time that an unbooked reservation record is allowed to persist in the reservation system 12. To this end, the time limit feature may delete reservation records that have not been booked within a specified period of time. The time period may be defined based on one or more criteria, such as the date the reservation record was created, an origination/destination pair of a reserved flight, a booking class, or any other suitable criterion.

If a reservation record is deleted by the time limit feature, the yield generator 20 may be notified so that corresponding tickets in the composite ticket database 70 can be deleted to maintain synchronization with the reservation system 12. More generally, any update to an unbooked reservation record in the reservation system 12 may trigger a corresponding update of the associated proxy ticket in the ticketing system 14, which in turn may trigger an update to the composite ticket database 70.

Another issue that may arise when using unbooked reservation records to generate yield data is that travel products in unbooked reservation records may be unpriced. To remedy this issue, the yield generator 20 may query the fare system 16 to price proxy tickets in the composite ticket database. New queries for existing proxy tickets may be launched periodically (e.g., once a day) so that fare updates are captured in the composite ticket database 70. Pricing may be performed dynamically by using an interactive request (e.g., transmitting a FITQPQ message to the fare system 16), or in batch mode, such as by transmitting the proxy tickets in the form of a file. In other cases, the ticketing system 14 may perform pricing for the proxy tickets as they are generated, and transmit the pricing data to the composite ticket database 70 along with the proxy ticket. Once priced, reserved proxy tickets may be used to provide pricing to the yield engine 68 until the underlying reservation is deleted from the reservation system 12, the reserved proxy ticket is replaced with an updated image in the ticketing system, or the reserved proxy ticket is replaced by a booked ticket.

As can be seen from bars 84b and 84c of bar graph 72, tickets and reserved proxy tickets may only provide a portion of expected demand, and may tend to provide less information as the time horizon extends further into the future. To fill this gap, simulated reservation records may be generated in the simulated reservation database 58 of reservation system 12. To this end, a simulated traveler demand may be generated for the travel product over a reservation window extending from t=0 until t=+N (e.g., from today until 365 days into the future). This demand may be determined based on a historical demand for tickets, and may include adjustments to account for events that are expected to change demand, e.g., new competitors entering a market, higher traffic from an expected increase in tourism, or any other event expected to affect demand.

The predicted traveler demand may be processed for bookings by emulating the reservation system 12, carrier inventory system, and traveler behavior for each time period in the reservation window. The output of this process may be simulated reservation records, which may be stored in the simulated reservation database 58. The simulated reservation records may be generated based on historical ticket sales, taking into account existing booked tickets and reserved proxy tickets for each period of time.

Once the simulated reservation records have been generated, the simulated reservation database 58 may be scanned, and unticketed simulated reservation records forwarded to the ticketing system 14. The ticketing system 14 may process the received simulated reservation records using a dedicated parallel ticketing process that is separate from the ticketing process used for actual bookings The output of the parallel ticketing process may be simulated proxy tickets, which may be stored in the simulated proxy ticket database 66. The simulated proxy tickets may have the same structure as regular booked tickets, which may allow them to be processed by the yield engine 68 using the same processes as used with booked tickets, e.g., interactive feeding, file dumping, and database querying.

The composite ticket database 70 may include tickets from four sources, namely used tickets (i.e., historical data), unused booked tickets, reserved proxy tickets generated from existing reservations that have not been booked, and simulated proxy tickets generated from simulated reservation records. Each of these four sources of data may be used by the yield engine 68 to generate yields for units of time between t=0 and t=+N. The tickets in the composite ticket database 70 may have the same origin, destination, point of sale, date, booking class, etc. as the tickets for which yield is being generated, which may facilitate the yield generation process.

The yield engine 68 may generate a yield for a specific set of criteria by generating an average price paid by all the passengers that have bought a unit of inventory that satisfies the set of criteria. In an embodiment of the invention, the yield may be generated using a linear combination of these four data sources as follows:

$$Yield = \frac{{W}_{1} \times \sum {P}_{U} + {W}_{2} \times \sum {P}_{B} + {W}_{3} \times \sum {P}_{RP} + {W}_{4} \times \sum {P}_{SP}}{{W}_{1} \times {N}_{U} + {W}_{2} \times {N}_{B} + {W}_{3} \times {N}_{RP} + {W}_{4} \times {N}_{SP}}$$

where weighting coefficients W₁-W₄ each represent a corresponding weight assigned to the data source, i.e. a confidence factor attributed to each data source, ΣP_{U} is the sum of the prices of used tickets, ΣP_{B} is the sum of the prices of unused booked tickets, ΣP_{RP} is the sum of the prices of reserved proxy tickets, ΣP_{SP} is the sum of the prices of simulated proxy tickets, N_{U} is the number of used tickets, N_{B} is the number of unused booked tickets, N_{RP} is the number of reserved proxy tickets, and N_{SP} is the number of simulated proxy tickets.

Weighting coefficients may be dynamic, and may vary in dependence on selected criteria, such as data source quality, route, market, time/date range, or any other suitable criteria. The weighting coefficients may be thought of as confidence factors, so that the more accurate the data is believed to be, the higher the value of the corresponding weighting coefficient. For example, on a route affected by recent geopolitical events, the weighting coefficients may be adjusted to give less weight to used ticket data, which may be less predictive due to changes in the pricing environment, and more weight to unused and simulated ticket data, since future data may better represent new market trends.

By way of example, a yield value is calculated below for the following set of criteria: origin=CDG (Paris Charles de Gaulle), destination=LHR (London Heathrow), point of sale=FR (France), travel date=May 10, 2014, and booking class=Y. Further assuming that we have the following ticket data in the composite ticket database:

| | |
|---|---|
| Used Tickets | CDG, LHR, FR, 10 MAY 2013, Y, $180 |
| | CDG, LHR, FR, 10 MAY 2013, Y, $160 |
| | CDG, LHR, FR, 10 MAY 2013, Y, $172 |
| Booked/Unused Tickets | CDG, LHR, FR, 10 MAY 2014, Y, $156 |
| | CDG, LHR, FR, 10 MAY 2014, Y, $190 |
| Reserved Proxy Tickets | CDG, LHR, FR, 10 MAY 2014, Y, $162 |
| Simulated Proxy Tickets | CDG, LHR, FR, 10 MAY 2014, Y, $151 |
| | CDG, LHR, FR, 10 MAY 2014, Y, $184 |
| | CDG, LHR, FR, 10 MAY 2014, Y, $169 |

and the following weighting coefficients W₁=180, W₂=130, W₃=60, W₃=80, solving the above exemplary yield equation using the above values yields:

$$Yield = \frac{\begin{matrix}180 \times ( 180 + 160 + 172 ) + 130 \times ( 156 + 190 ) + \\ 60 \times ( 162 ) + 80 \times ( 151 + 184 + 169 )\end{matrix}}{180 \times 3 + 130 \times 2 + 60 \times 1 + 80 \times 3}$$

which simplifies to

Yield=$170.16

The above calculation may be repeated to determine a yield for each set of criteria.

The weighting coefficients may be set by the provider of the travel product based on empirical knowledge of the market for which yield is being determined. Weighing coefficients may also be set using an iterative method. For example, the weighting coefficients may be initially set to a value of 1, and yields generated using all available data sources. The accuracy of the resulting yield may be monitored, and the weighting coefficients adjusted to match the results using a fitting method, such as a least squares method. This process may then repeated until the yield is considered sufficiently accurate. Where sufficient historical data is available, weighting coefficients may also be determined using back-testing.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatus, or other devices to function in a particular manner, such that the instructions stored in the computer-readable medium produce an article of manufacture including instructions that implement the functions, acts, and/or operations specified in the flow-charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system comprising:
one or more processors; and
a memory coupled to the one or more processors, the memory storing data comprising program code that, when executed by the one or more processors, causes the system to:
determine, prior to a first perish date of a first product, a first price for a first unit of the first product which is reserved;
determine, prior to the first perish date, a second price for a second unit of the first product which is available;
determine, prior to the first perish date, a third price paid for a third unit of a second product having a second perish date which has passed; and
determine a yield for a remaining inventory of the first product based on a weighted sum comprising the first price, the second price, and the third price.

2. The system of claim 1 wherein the program code causes the system to determine the first price by:
transmitting a query to a first database of reservation records, the query requesting the first database return reservation records for units of the first product that have been reserved; and
receiving a reservation record for an itinerary including the first unit from the first database,
wherein the first price is determined based on the reservation record.

3. The system of claim 2 wherein the program code causes the system to determine the first price based on the reservation record by:
querying a second database of tickets for a ticket issued for the first unit; and
setting the first price equal to an amount charged for the ticket.

4. The system of claim 2 wherein the program code further causes the system to:
generate a proxy ticket for the first unit based on the reservation record;
determine a pricing context for the proxy ticket; and
price the proxy ticket using the pricing context to determine the first price.

5. The system of claim 4 wherein the program code further causes the system to:
detect a change in a reservation context for the reservation record;
in response to detecting the change, re-price the proxy ticket using the changed reservation context to update the first price; and
update the yield based on the updated first price.

6. The system of claim 4 wherein the proxy ticket is stored in a second database of proxy tickets, and the program code further causes the system to:
detect a change to the reservation record in the first database; and
in response to detecting the change, update the proxy ticket in the second database.

7. The system of claim 1 wherein the program code causes the system to determine the first price by:
transmitting a query to a database of tickets, the query requesting the database return tickets for units of the first product that have been purchased; and
receiving a first ticket from the database, the first ticket including the first price.

8. The system of claim 7 wherein the program code further causes the system to:
detect a change in a status of the first ticket; and
in response to detecting the change, update the first price.

9. The system of claim 1 wherein the program code causes the system to determine the second price for the second unit of the first product by:
determining an expected demand for the first product;
based on the expected demand, generating a simulated reservation request for the second unit of the first product;
determining an availability of the first product based on the remaining inventory;
in response to the availability being sufficient to satisfy the simulated reservation request, generating a simulated reservation record for the second unit;
generating a proxy ticket for the simulated reservation record;
determining a pricing context for the proxy ticket; and
pricing the proxy ticket using the pricing context to produce the second price.

10. A method of determining a yield for a remaining inventory of a first product having a first perish date, the method comprising:
determining, by a server prior to the first perish date, a first price for a first unit of the first product which is reserved;
determining, by the server prior to the first perish date, a second price for a second unit of the first product which is available;
determining, by the server prior to the first perish date, a third price paid for a third unit of a second product having a second perish date which has passed; and
determining the yield for the remaining inventory based on a weighted sum comprising the first price, the second price, and the third price.

11. The method of claim 10 wherein determining the first price comprises:
transmitting a query to a first database of reservation records, the query requesting the first database return reservation records for units of the first product that have been reserved; and
receiving a reservation record for an itinerary including the first unit from the first database,
wherein the first price is determined based on the reservation record.

12. The method of claim 11 wherein determining the first price based on the reservation record comprises:
querying a second database of tickets for a ticket issued for the first unit; and
setting the first price equal to an amount charged for the ticket.

13. The method of claim 11 further comprising:
generating a proxy ticket for the first unit based on the reservation record;
determining a pricing context for the proxy ticket; and
pricing the proxy ticket using the pricing context to determine the first price.

14. The method of claim 13 further comprising:
detecting a change in a reservation context for the reservation record;
in response to detecting the change, re-pricing the proxy ticket using the changed reservation context to update the first price; and
updating the yield based on the updated first price.

15. The method of claim 13 wherein the proxy ticket is stored in a second database of proxy tickets, and further comprising:
detecting a change to the reservation record in the first database; and
in response to detecting the change, updating the proxy ticket in the second database.

16. The method of claim 15 wherein the change to the reservation record comprises deletion of the reservation record, or generation of a booked ticket for the first unit.

17. The method of claim 10 wherein determining the first price comprises:
transmitting a query to a database of tickets, the query requesting the database return tickets for units of the first product that have been purchased; and
receiving a first ticket from the database, the first ticket including the first price.

18. The method of claim 17 further comprising:
detecting a change in a status of the first ticket; and
in response to detecting the change, updating the first price.

19. The method of claim 10 wherein determining the second price for the second unit of the first product comprises:
determining an expected demand for the first product;
based on the expected demand, generating a simulated reservation request for the second unit of the first product;
determining an availability of the first product based on the remaining inventory;
in response to the availability being sufficient to satisfy the simulated reservation request, generating a simulated reservation record for the second unit;
generating a proxy ticket for the simulated reservation record;
determining a pricing context for the proxy ticket; and
pricing the proxy ticket using the pricing context to produce the second price.

20. A computer program product for determining a yield for a remaining inventory of a first product having a first perish date, the computer program product comprising:
a non-transitory computer-readable storage medium; and
program code stored on the non-transitory computer-readable storage medium that, when executed by one or more processors, causes the one or more processors to:
determine, prior to the first perish date, a first price for a first unit of the first product which is reserved;
determine, prior to the first perish date, a second price for a second unit of the first product which is available;
determine, prior to the first perish date, a third price paid for a third unit of a second product having a second perish date which has passed; and
determine the yield for the remaining inventory based on a weighted sum comprising the first price, the second price, and the third price.
